(19) United States
(12) Patent Application Publication
(10) Pub. No.: US 2003/0105723 A1
(43) Pub. Date: Jun. 5, 2003

(54) Method and system for disclosing information during online transactions

(76) Inventor: Alan Skea, London (GB)

Correspondence Address: GORDON E NELSON, PATENT ATTORNEY, PC, 57 CENTRAL ST, PO BOX 782, ROWLEY, MA, 01969, US

(21) Appl. No.: 10/220,457

(22) PCT Filed: Feb. 27, 2001
(86) PCT No.: PCT/GB01/00833

(51) Int. Cl. G06F 17/60

(52) U.S. Cl. 705/64

(57) ABSTRACT

The amendment under Article 19 is intended to emphasize an important feature of the invention, namely that there is an implicit contract between the user and a provider with which the user interacts via the network that the provider will not keep the information contained in a cookie which the provider makes for the user and the user returns to the provider during a transaction between the user and provider between transactions and that the implicit contract is part of the system's interface with the user. This feature is fully supported by the Specification as originally filed. See in this regard at least page 12, line 18-page 13, line 5 and FIGS. 12 and 15.

### CROSS REFERENCES TO RELATED APPLICATIONS

The present patent application claims priority from U.S. Provisional Patent Application 60/185,624, Alan Skea, Method and system for disclosing information during online transactions, filed Feb. 29, 2000.

### BACKGROUND

1. Field of Invention

This invention relates to the communication of possibly sensitive information amongst parties to a transaction carried out over a computer network such as the Internet.

b 2. Description of Prior Art

Computer networks, and in particular the Internet, are increasingly being used for the exchange of information as part of various transactions. A common example of this is the use of the Internet to transact the purchase of goods or services. A customer uses a computer connected to the Internet to retrieve descriptions of the goods or services from a vendor's system and to transfer purchasing information to the vendor's system. The purchasing information is typically the customer's credit card details for payment, the customer's address for delivery and some indication of the item or items that are being purchased.

Present day techniques for making transactions using computer networks have problems including:

the fact that information received from the customer during the transaction remains in the vendor's hands after the transaction;

Many of the techniques used for making transactions on the internet require that the vendor agree to standard techniques for transferring and storing information; and

Many of the techniques require that the customer have special hardware and/or software. Beginning with the problem of retention of information received from the customer, a vendor will often not make direct use of all of the information themselves but will pass some of it on to other parties to effect part of the transaction. For example, merchants often pass a customer's credit card information along with purchase price and merchant account information to a credit card clearing agent or payment services provider. The merchant has no real need for the credit card information themselves except to pass it along to their clearing agent. Similarly, delivery of goods may be carried out on behalf of the merchant by a delivery agent. If so then the merchant has no need for the customer's address except to pass on to the delivery agent along with the goods to be delivered and any other information that the delivery agent might require from the merchant.

In both these examples the merchant concludes the transaction in possession of information which is not essential for their part in the transaction and which the customer might prefer not to disclose. Once disclosed the customer has little or no control over what the vendor might do with the information and despite vendor assurances and privacy policy statements, there are regular news stories reporting failures of vendor data security or dubious vendor data practices.

The problem of retained information is has been aggravated by the widespread use of certain techniques for streamlining the process of placing an order over the Internet. For example, in U.S. Pat. No. 5,960,411 to Hartman et al. (1999), a system is proposed whereby a merchant maintains a database of customer information and identifiers. On returning to a merchant using this system, a customer's system automatically provides a previously assigned identifier (known as a cookie). This identifier is then used to retrieve the customer's data from the database and the customer need not re-enter their credit card, delivery address or other details. Using this or a similar system a customer might place an order with only a few interactions with the merchant's system. While this might be a very compelling proposition to many customers, it requires that they permit the merchant to store the information for longer than the time required for a single transaction. In granting this permission the customer foregoes any control they have over the use of the information. The merchant may make certain assurances regarding their intended use of the information but these are not binding and the customer runs a further risk that the information may be unintentionally or maliciously disclosed to third parties.

In addition to the concerns regarding the loss of control over the information, a customer has the problem of maintaining the currency and validity of the information that might be kept in various merchants' databases. Unless the customer only ever buys from one merchant, there are likely to be a number of merchants to whom the customer has disclosed information for storage in a database. If the customer's details change (perhaps the customer's credit card expires and is replaced by a new one) then the customer must update this information with each of the merchants with whom they have regular dealings.

Retention of information is also a problem with “electronic wallets”. Some kinds of electronic wallets also require specialized software and other kinds are limited by the lack of standards. There are two main types of electronic wallets. The first type requires that the customer install a piece of software on their computer which manages their personal information and the communication of this information to merchants. While this software preserves control over the customer's information and provides a central location for information maintenance, it needs to understand exactly how each merchant requires the information to be presented and interact with that merchant accordingly. This is a monumental task and will always be one step behind the new features that merchants may offer. Customer's will be caught up in a cycle of perpetual upgrades and the electronic wallet software manufacturers will have the task of trying to convince merchants to use a rigid format for acquisition of customer information. In cases where an unusual piece of information is needed, the customer will have to bypass the electronic wallet software and interact with the merchant directly.

The second main type of electronic wallet allows customers to give custody of their information to an electronic wallet system which is hosted on a remote system. This system stores the customer's information in a database and gives the customer an identifier to be used when shopping. In addition to requiring the trust of the customer and the data security risks associated with building databases full of customer data, this system also has the problem that it must convince merchants to participate and it cannot be used at non-participating merchants. Since there are several providers of this sort of electronic wallet it is likely that there will not be any one dominant provider and merchants will have to choose which, if any, provider to work with. To achieve streamlined transactions with all merchants who offer electronic wallet based shopping, customers will have to submit their information to many electronic wallet providers. While the number of electronic wallet providers is likely to very much less than the number of merchants, there will still be a number of places at which a customer will need to maintain the currency and validity of their information.

Another big drawback with submitting information to an electronic wallet provider is that the provider can monitor the customer's shopping behaviour at all participating merchants and draw inferences about the customer's lifestyle and future behaviour. This information can then be used by other organisations to target promotions for their goods and services and the provision of this information to these other organisations can provide a source of revenue for the electronic wallet provider. Many customers would prefer not to have their behaviour monitored in this way.

As with the method of Hartman et al., at the conclusion of a transaction which has been mediated by an electronic wallet, the vendor is in possession of customer data that they no longer need and which the customer might prefer them not to have. Again the customer has lost control over the uses to which their data might be put.

Many systems have been proposed to protect customer data while it is in transit during a transaction. Currently the most commonly used method on the Internet is the Secure Sockets Layer (SSL) which uses strong encryption to protect the data in transit and is built into most Internet browsing software. Many writers speculate that such a system is not strong enough to prevent network eavesdroppers from acquiring the data and propose systems that attempt to provide a more secure solution. U.S. Pat. Nos. 5,903,721 to Sixtus, 5,883,810 to Franklin et al. and 6,000,832 to Franklin et al. all propose such systems. What they and other such systems all neglect is the practical reality that the data in transit that is encrypted using SSL is protected to a much greater degree than data stored on a vendor's system. There are know security problems with all the major operating systems that are used by vendors for Internet commerce and there is little point in improving the security of data in transit when the data stored on a vendor's system or an electronic wallet provider's system is more vulnerable. A serious data thief will try to compromise security at the weakest point where there are likely to be rewards which make the effort worthwhile. Each customer-vendor session using SSL has different encryption and it is likely that a separate effort would be needed to compromise each session and obtain a single customer's data. On a vendor's system they are likely to find the data records of many customers protected by the security system inherent in the vendor's operating system. This operating system is likely to have known security flaws and new security flaws are being constantly discovered. This is the point that most data-thieves will attack and where developments in data security are needed.

The requirements of special hardware or software and the lack of standards are barriers to adoption of many proposed systems for doing transactions via a network. If the customers have to download a piece of software, or give their data to a “trusted provider” then there is a barrier to customer adoption. If the vendor has to make arrangements with each and every trusted provider then there is a barrier to vendor adoption. Unless both the customers and the vendors are likely to gain significantly from the adoption of a new system and lose nothing or very little, then it is likely that the barriers will be too great and the system will not achieve the market penetration necessary for it to be a commercial success. Good examples of this are the Secure Electronic Transactions protocol (SET) and Digicash. SET required customers and vendors to obtain certificates before they could participate and provided added benefits in the form of fraud reduction to only the credit card companies. Digicash arranged for special electronic tokens to be sold to customer who stored them for later spending. The tokens could be authenticated but contained no customer data so any purchase could be anonymous. This required a big leap of faith on the part of the customers and vendors that the tokens wouldn't be lost by anyone involved in the transactions and that the value of the tokens would be stable. It is an object of the invention to overcome the above and other problems of present-day techniques of performing transactions over networks.

### SUMMARY OF THE INVENTION

The invention solves the problems posed by vendor retention of information provided by customers, by the lack of standard systems, and by the need with many systems to employ special software and/or hardware by adapting the standard HTTP protocol to make a system which makes it so easy for a customer (or broadly, a user) to provide a vendor with transaction-invariant information about the user that there is no need for the vendor to retain such transaction-invariant information between transactions. Transaction-invariant information is simply information about the user that generally does not change between transactions. The system is implemented in a service program running in a server system that interacts with a user agent that is running in a system used by the customer. One example of a user agent is a browser; other examples are be similar programs executing in portable devices such as palm computers or cellular telephones or in television sets or smart telephones.

The user agent is a typical user agent such as a browser program that has been improved by including transaction-invariant user information that is stored in the user agent. The transaction-invariant user information permits the service to perform the transaction without requiring the user to input additional transaction-invariant information user information during the transaction and an operation in the browser automatically provides the transaction-invariant user information to the service. The operation that provides the transaction-invariant user information requires substantially less interaction by the user with the user agent than that required to input the transaction-invariant user information to the user agent.

The service is a typical service executing in a server which has been improved in that the service receives the user agent-stored transaction-invariant user information in the service during the transaction and uses the transaction-invariant user information to perform the transaction without either using transaction-invariant user information retained from a previous transaction between the provider and the user or requiring the user to input additional transaction-invariant user information during the transaction.

The transaction-invariant user information may include information such as personal identification information for the user, information which may be provided to another participant in the transaction who vouches for the user with regard to the transaction, contact information for the user, delivery information for an item being shipped as a result of the transaction, or payment information.

In one embodiment of the invention, the user employs the user agent to input the transaction-invariant user information to the service. The service uses the transaction-invariant user information to make the user agent-stored transaction-invariant user information and returns the transaction-invariant user information to the user agent, which stores it for later use. In the embodiment, the service and the user agent employ the HTTP protocol and the service returns the transaction-invariant user information to the user agent as a cookie.

In another aspect of the invention, more than one service may participate in the transaction and one of the services may provide another of the services with a transaction identifier that identifies the transaction via the user agent. The services can then use the transaction identifier to identify information that one service sends the other regarding the transaction.

### OBJECTS AND ADVANTAGES OF THE INVENTION

Accordingly, several objects and advantages of the present invention are:

(a) that providers need never be given any more than the bare minimum of information that is necessary to effect their part of the transaction. For goods or services that can be delivered entirely electronically or which are collected from the providers by the customer or an agent of the customer, the transaction can be entirely anonymous. Similarly, a credit card agency need never know what items the customer is purchasing, only the identity of the provider making the sale and the amount to be charged to the customer;

(b) that a customer has custody of their own information and can change it, make it unavailable, limit its validity or destroy it at will;

(c) that the customer can store the information required by a particular provider once and use the stored information many times without re-entering;

(d) that if the customer's information changes or expires then the customer need only update the copy stored on their own system;

(e) that once information is stored on the customer's system transactions are streamlined and may be carried out with very few interactions with a provider. This is convenient for the customer, lowers the barriers to online purchasing and facilitates impulse buying;

(f) that the invention can be implemented using a combination of existing features of Internet protocols. Most customers who already use Internet software need not upgrade or install any new software to make use of this invention on the Internet.

Further objects and advantages of the invention will become apparent from a consideration of the drawings and ensuing description.

### DRAWINGS FIGURES

In the drawings closely related figures have been given the same number but different suffixes.

FIG. 1 is a block diagram illustrating a customer's system in an embodiment of this invention.

FIG. 2 is a block diagram illustrating a provider's system in an embodiment of this invention.

FIG. 3 illustrates the use of the method of this invention in a transaction involving a customer and a single provider.

FIG. 4 illustrates the use of the method of this invention in a transaction involving a customer and two providers.

FIG. 5A illustrates the use of the method of this invention in a transaction involving a customer and three providers where all providers act equally on their own behalf.

FIGS. 5B-550 through 5B-585 show the HTTP request-line and headers for the requests and the HTTP status-line and headers for the replies that are used in a transaction using the method of this invention involving a customer and three providers such as is shown in FIG. 5A. The numeric suffix on the figure number corresponds to the request or reply of the same number shown in FIG. 5A. Lines numbers have been added and long lines have been folded at the margins to fit on the page. Line 1 in each figure is always either a request-line (for requests) or a status-line (for replies). The remaining lines are all HTTP headers.

FIG. 6A illustrates the use of the method of this invention in a transaction involving a customer and three providers where one of the providers acts as an information manager on behalf of the other providers.

FIGS. 6B-650 through 6B-675 show the HTTP request-line and headers for the requests and the HTTP status-line and headers for the replies that are used in a transaction using the method of this invention involving a customer and three providers such as is shown in FIG. 6A. The numeric suffix on the figure number corresponds to the request or reply of the same number shown in FIG. 6A. Line numbers have been added and long lines have been folded at the margins to fit on the page. Line 1 in each figure is always either a request-line (for requests) or a status-line (for replies). The remaining lines are all HTTP headers.

FIG. 7 is a flow diagram of a routine for a first provider's system that creates a Web page in which transactions using the method of this invention are enabled.

FIG. 8 is flow diagram of a routine for a first provider's system that uses the method of this invention to continue the processing of a transaction.

FIG. 9 is a flow diagram of a routine for a first provider's system that uses the method of this invention to complete the processing of a transaction.

FIG. 10 is a flow diagram for a routine for a second provider's system that uses the method of this invention to collects customer data for a possible transaction.

FIG. 11 is a flow diagram of a routine for a second provider's system that uses the method of this invention to assemble all transaction data, to process the transaction and return the result to a first provider's system.

FIG. 12 is a screenshot taken on a customer's system of a secure form produced by a second provider's system for the management of credit card data.

FIG. 13 is a screenshot taken on a customer's system of a dialogue message displayed when a second provider's system passes encrypted information to a customer's system for storage in the form of a cookie.

FIG. 14 is a screenshot taken on a customer's system of a secure confirmation screen produced by a second provider's system showing the credit card data that was received, encrypted and sent back to the customer's system as a cookie.

FIG. 15 is a screenshot taken on a customer's system of a secure form produced by a second provider's system for the management of delivery address data.

FIG. 16 is a screenshot taken on a customer's system of an insecure page produced by a second provider's system that summarises a proposed transaction and allows the customer to vary the transaction parameters and accept or reject the transaction.

FIG. 17 is a screenshot taken on a customer's system of a secure form produced by a second provider's system for the management of transaction preferences which could streamline a transaction.

FIGS. 18A and 18B show the request-line and headers from an HTTP request and the status-line and headers from an HTTP reply that use the method of this invention to store user-information at the user's machine in the form of an encrypted cookie.

FIG. 19 shows some extracts from the HTTP specification that give the format for an HTTP message.

### DESCRIPTION AND OPERATION OF THE INVENTION

Background to Network Protocols

Much of the following discussion refers to example embodiments that use the HTTP protocol, the specifications of which can be found at the web site of the World Wide Web Consortium:

http://www.w3.org/Protocols/HTTP/1.1/rfc2616.txt.gz

http://www.w3.org/Protocols/rfc1945/rfc1945

Also relevant to the discussion are the extensions to this specification which provide for cookies and which were proposed by Netscape in:

http://home.netscape.com/newsref/std/cookie spec.html

and revised and formalised (though the revisions are not yet widely used) in the later proposals:

http://www.w3.org/Protocols/rfc2109/rfc2109

http://portal.research.bell-labs.com/˜dmk/cookie-3.12.txt

The HTTP cookies used as examples in this document conform to the earlier Netscape specification.

Although the discussion here uses HTTP as an example, other technologies also lend themselves to use of this invention. The Wireless Application Protocol (WAP) is one such other technology. The specification for the Wireless Session Protocol layer of the WAP protocol stack:

http://www1.wapforum.org/tech/terms.asp?doc=WAP-203-WSP-20000504-a.pdf

states that:

The core of the WSP design is a binary form of HTTP

The WSP specification includes an equivalent of the HTTP cookies and it is clear from this and on further reading of the WSP specification that it too could use the method of this invention.

Section 4.1 of the HTTP/1.1 specification (rfc2616) describes the structure of an HTTP as follows:

HTTP messages consist of requests from client to server and responses from server to client. Request and Response messages use the generic message format of RFC 822 for transferring entities (the payload of the message). Both types of message consist of a start-line, zero or more header fields (also known as “headers”), an empty line (i.e., a line with nothing preceding the CRLF) indicating the end of the header fields, and possibly a message-body.

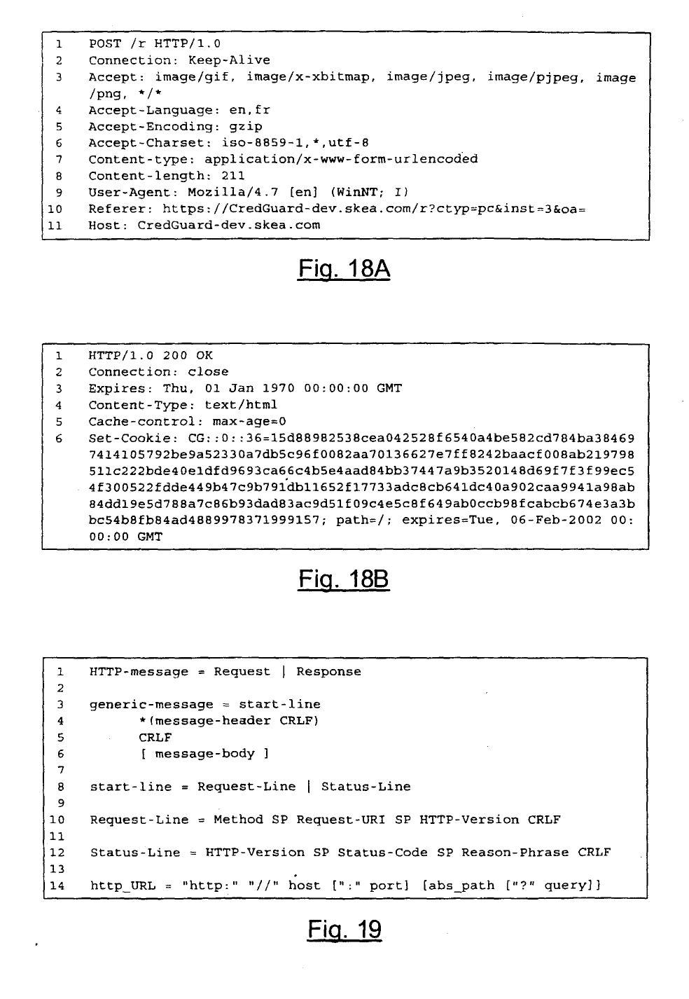

FIG. 19 shows the syntax of an HTTP message as given in the specification. There are two kinds of messages: request messages which the browser sends to the service and response messages which the service sends to the client in response to request messages. The important parts of these messages for the purposes of the example embodiments of this invention are the Request-line for HTTP requests, the Status-line for HTTP responses, and the message-headers for both requests and replies. The Request-line contains the Request-URI which is the network name for the resource that is being requested. Line 14 of FIG. 19 shows the syntax of an http-URL which is the particular type of Request-URI used in the HTTP protocol. Other information may be associated with the Request-URI and this enables the client sending the request an opportunity to pass the extra information to the service for use in handling the request. In the present invention, the extra information includes a transaction identifier.

The Status line includes a status type. Of particular interest in the present context is the redirect status type. When the client receives a response message with the redirect status type, the client redirects the message to a service at a URI specified with the keyword location in the HTTP message header. As before, the URI may have other information such as a transaction identifier associated with the URI. The present invention uses a response message with the redirect status type and a URI with an associated transaction identifier to pass the transaction identifier from a first service to a second service via the client.

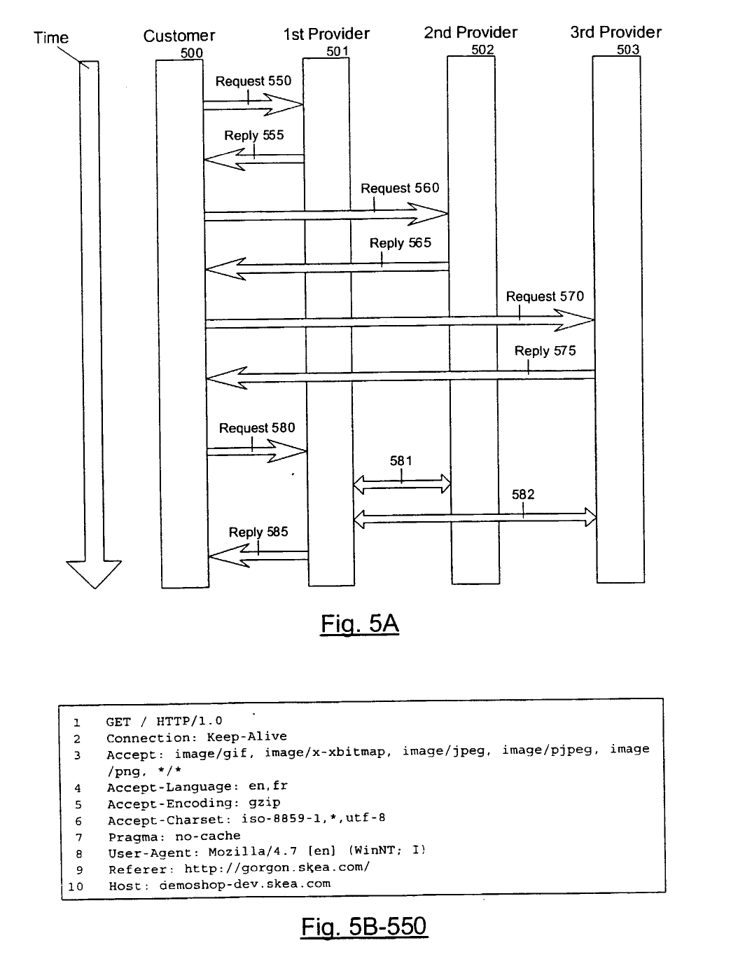

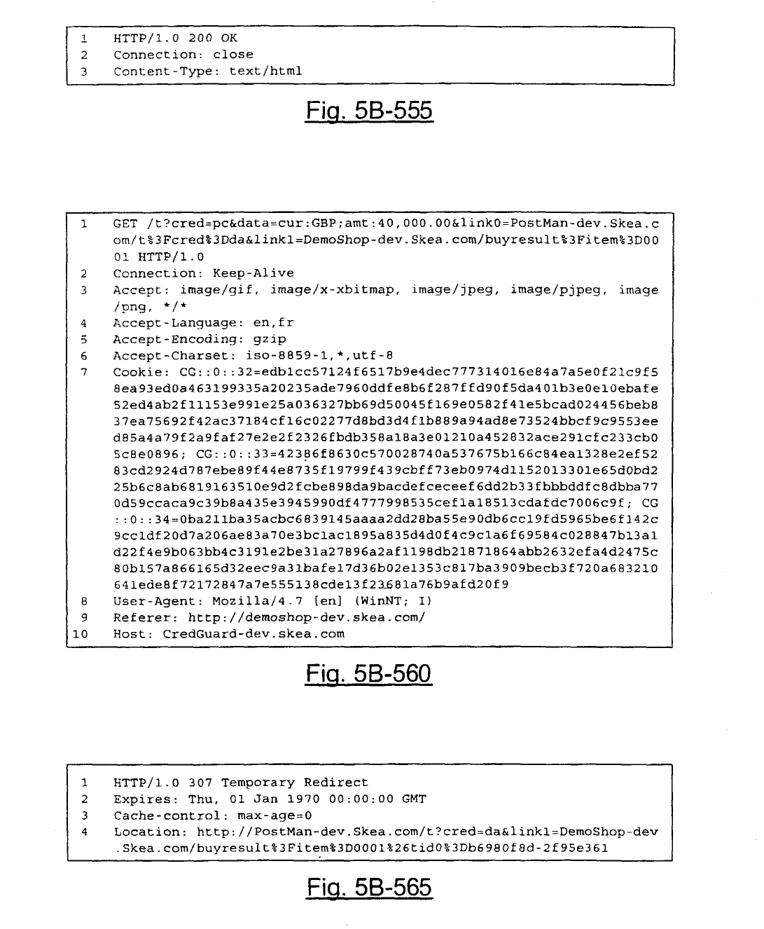

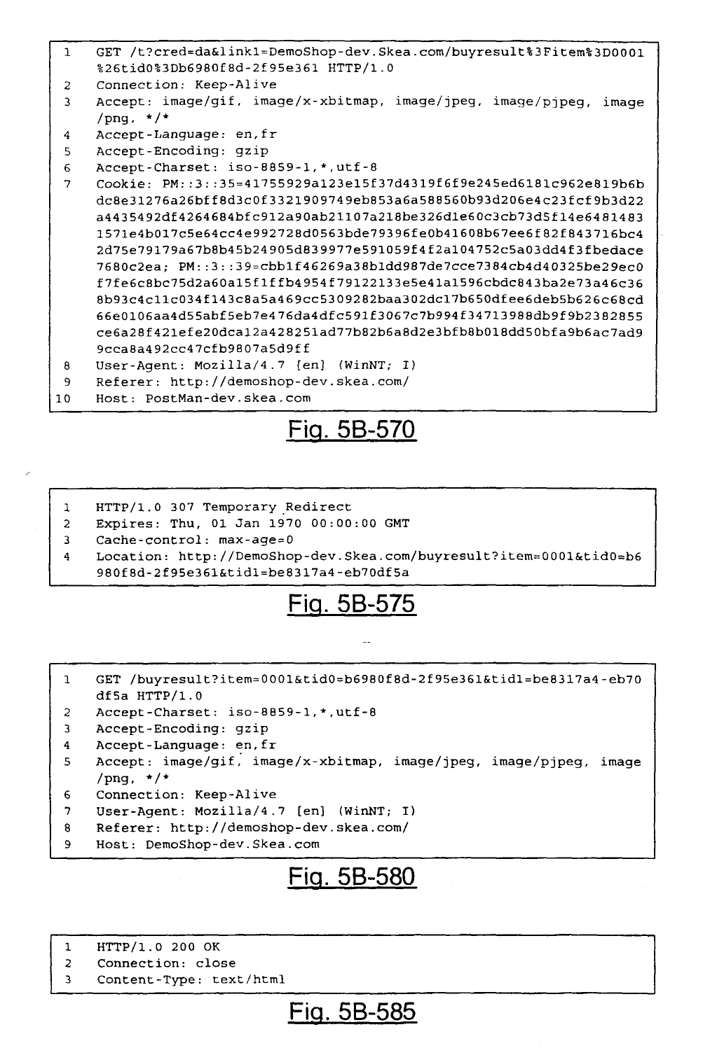

The message-headers may contain two headers which are of particular interest in the example embodiments of this invention. These are the Cookie: header that is used in Request messages (illustrated in FIG. 5B-560) and the Set-Cookie: header used in Response messages (illustrated in FIG. 18B). When a client receives a Response message containing a Set-Cookie header, it may store the contents of the header (the cookie) for later use in Request messages. Cookies are associated with a domain (a network address) and a path (the name of a resource at that address) and are only included in Request messages where the Request-URI matches the domain and path (if specified). If the domain and path are not specified in the Set-Cookie: header then the Cookie is associated with the current path at the responding host. In the normal course of operation this means that a server can store information at a client that will only ever be returned to itself. In the preferred embodiment, Set-Cookie is used to send a cookie containing transaction-invariant user information to the client and Cookie is the mechanism by which the cookie is automatically set to the service when a Request-URI specifies the service's domain and path.

Embodiments of the Invention

A typical transaction that might make use of this invention is the online sale of goods or services. There are two types of parties to the provision of the goods or services. The first type of party is a customer who is requesting the goods or services; the second type of party is a provider of the goods or services. While the transaction is discussed in terms of the customer and the provider in the following, it should be understood that the customer performs the actions ascribed to him or her by means of a user agent and the provider performs the actions ascribed to it by means of a service executing in a server. Each customer is in possession of various pieces of information which are necessary to the provision of the goods or services by various providers. This invention allows a customer to pass to various providers the information necessary for each provider to perform their part of a transaction. If there is more than one provider for a particular transaction then this invention also provides a method whereby a provider can share other information with other providers who are also involved in the transaction.

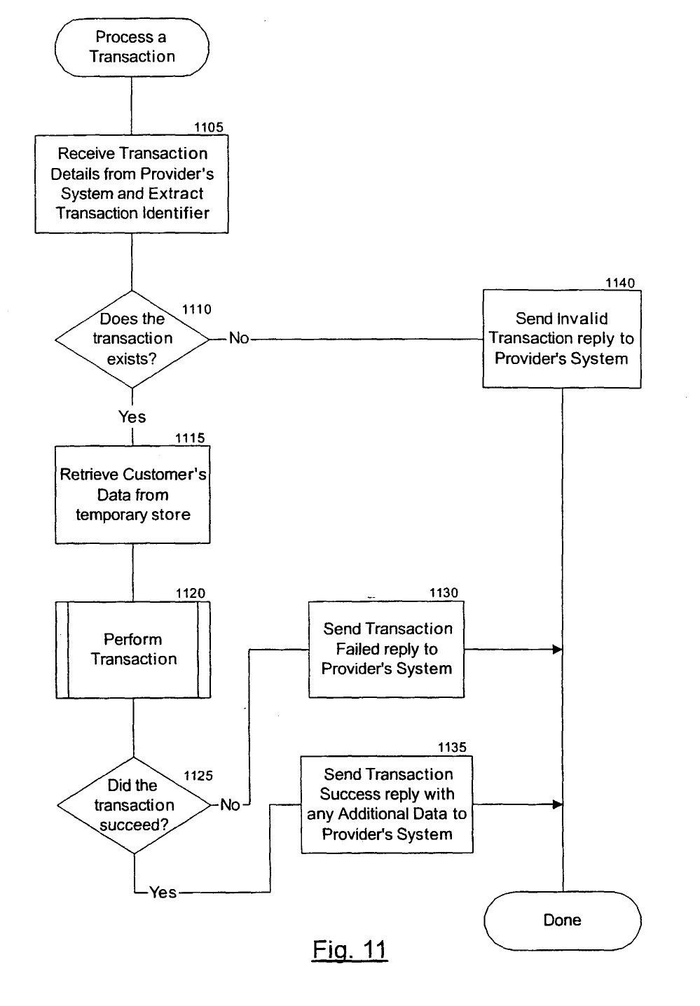

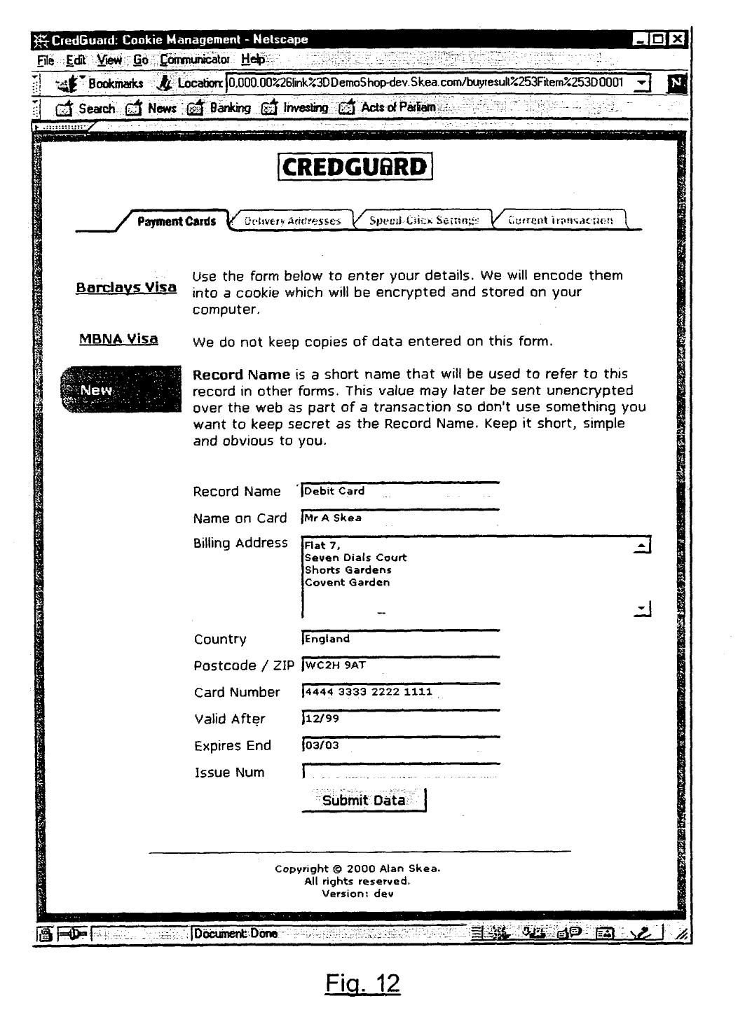

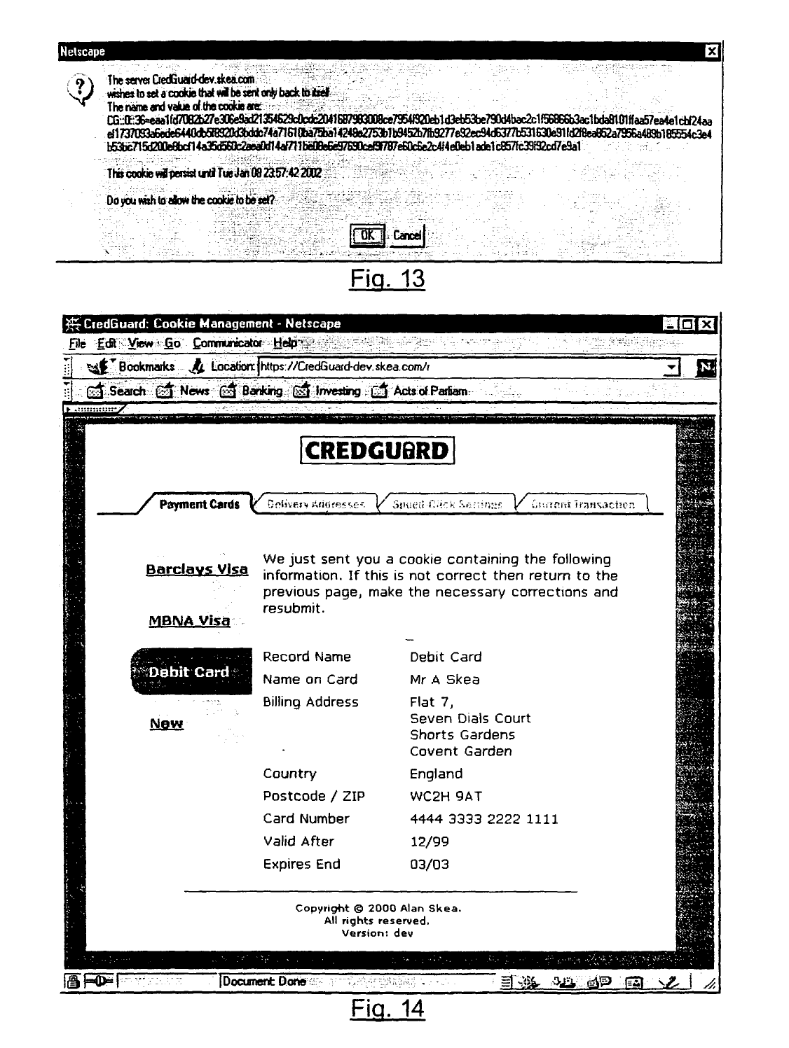

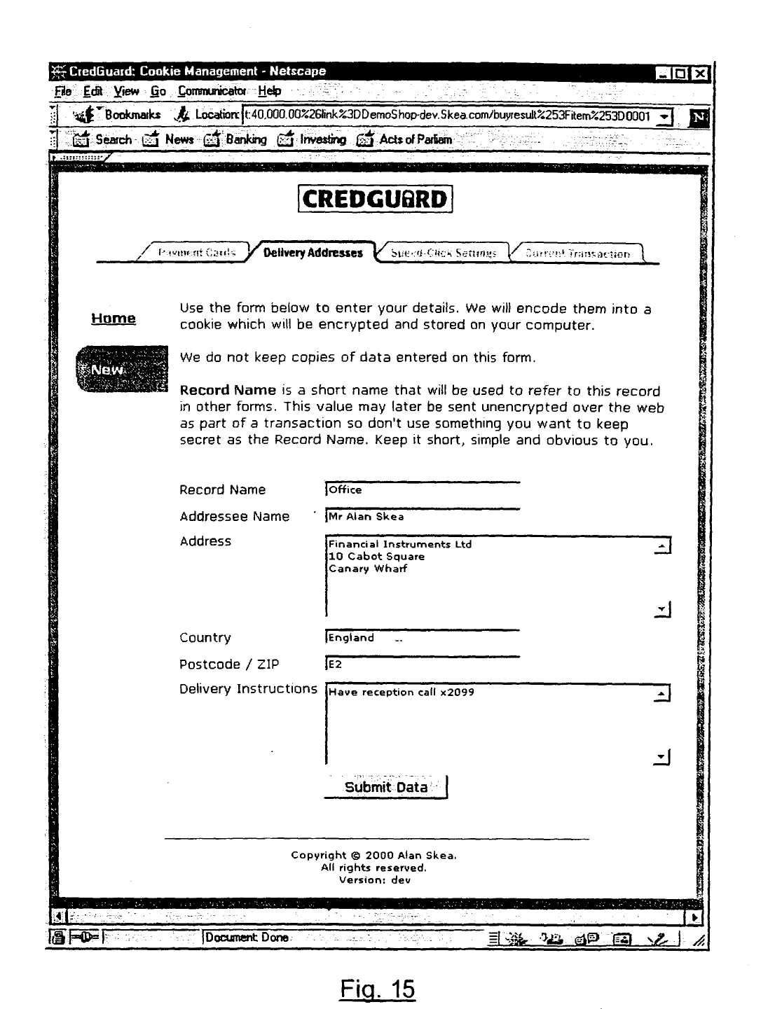

In order to use the method of this invention for transactions a customers must first arrange to record some of the information required for those transactions (the transaction-invariant user information) in such a way that it can be made available to the providers who will need this information to effect their part of a transaction. This step can be performed once and the recorded results used many times and although the information may change and need to be updated from time to time, for the most part it is transaction-invariant. In one embodiment of the invention the method for recording this information is for the customer to visit the web site of each provider involved in the transaction. At each provider's web site a form is made available and the information that will be required by that provider is entered by the customer into the form. FIGS. 12 and 15 show examples of such forms and FIG. 18A shows the request-line and headers from an HTTP request which sends the contents of such a form to a provider's system. The provider's system then constructs a token (commonly known as a cookie) and asks the customer's system to store the cookie. FIG. 13 shows a dialogue that might be displayed by the customer's system to confirm acceptance of such a cookie and FIG. 18B shows the status-line and headers from an HTTP reply that contains such a cookie at line 6. The provider may then discard the cookie and all the information gathered in the process of constructing the cookie. The cookie will automatically be included in any request that the customer's system might later send to the provider's system and at that time the provider can extract the information from the cookie. FIG. 5B-560 shows the request-line and headers from an HTTP request containing several such cookies at line 7.

With the cookies in place it is possible for the customer to use the method of this invention to enter into transactions involving those who also use the method of this invention.

FIG. 1 is a block diagram illustrating a customer's system in an embodiment of this invention. The customer's system 100 comprises a processing element 110, a memory 120, and an external interface 130. The memory element 120 contains a client module 121 comprising a program (the user agent) which can be executed by the processing element 110 and other data which may be required for the execution of the program. The memory element 120 may also contain a cookie table 122 comprising a collection of cookies that have been collected by the system during the course of its use.

The program in the client module 121 is capable of using external interface 130 to send requests to providers on behalf of the customer and to receive replies from these providers. These replies may result in further requests being sent to the same or other providers or may be communicated to the customer. The external interface 130 may include facilities for sending requests and receiving replies via local or wide-area networks including the Internet.

In this embodiment the means by which the customer specifies the requests to be sent, and the means by which the received replies are communicated to the customer are not a part of the customer's system 100. The external interface 130 is also used to receive requests from and send replies to external components or systems which perform these functions. One skilled in the art would see that these external components could equally well be part of the customer's system in a different embodiment of this invention.

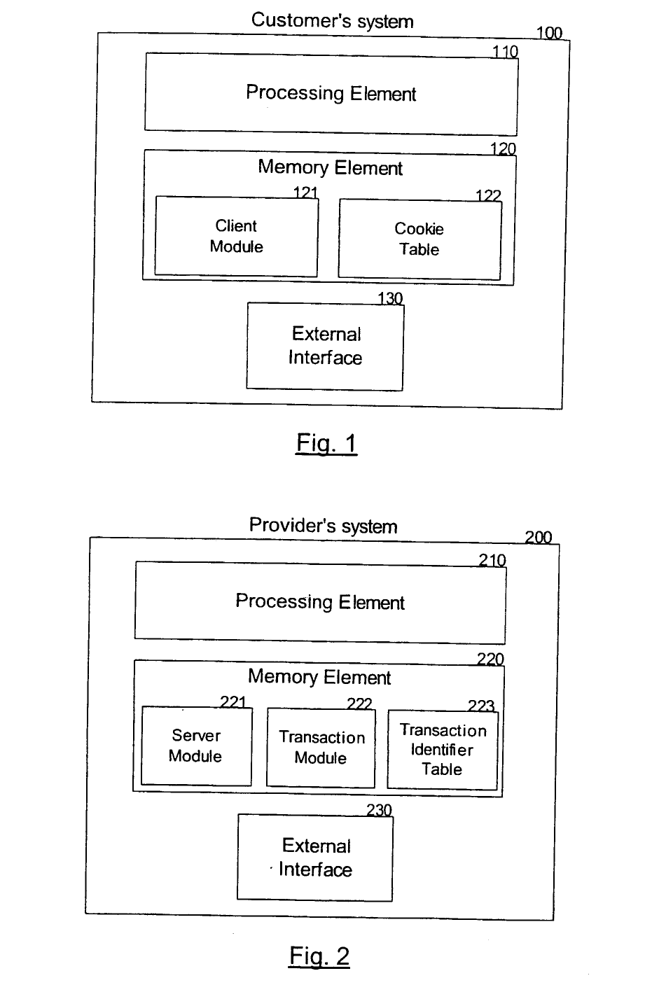

FIG. 2 is a block diagram illustrating a provider's system in an embodiment of this invention. The provider's system 200 comprises a processing element 210, a memory element 220 and an external interface 230. The memory element 220 contains a server module 221 comprising a program which can be executed by the processing element 210 and other data which may be required for the execution of the program. The memory element 220 also contains a transaction module 222 and a transaction identifier table 223. The transaction module 222 comprises a program (the service) which can be executed by the processing element 210 and other data which may be required for the execution of the program. The external interface 230 is used by the program to receive requests from and send replies to various other systems, possibly including facilities for communicating over local or wide-area networks including the Internet.

The program in the server module 221 is capable of receiving requests from and sending replies to customers or other providers, possibly making use of the transaction module 222 to provide the replies to be sent. This program might also be capable of extracting customer information from any cookies which might arrive as part of a request, allocating a transaction identifier and storing this along with the customer information in the transaction identifier table 223. The transaction identifier may be included in the reply sent to a request containing a cookie.

The program in the server module 221 may also be capable of extracting customer information from a request from a customer and constructing a cookie to be stored on the customer's system. The cookie is then sent to the customer as part of a reply to the request and the customer information is discarded.

The program in the transaction module 222 is capable of constructing a reply to a transaction request on behalf of the server module 221. The transaction requests may come from a customer or from another provider. On receiving a request this program attempts to locate a record in the transaction identifier table 223 which corresponds to an identifier supplied in the request. If found this program uses the information stored in this record and information from the request to execute the requested transaction. A reply is then constructed and passed back to the server module 221 to be sent.

The following examples show a variety of ways in which a customer's system can use the method of this invention to effect an online transaction with various providers' systems. Note that where the following examples refer to a credit card, other forms of charge card, debit card or other payment system might equally be used.

### FIRST EXAMPLE

Two Parties—Customer & Vendor

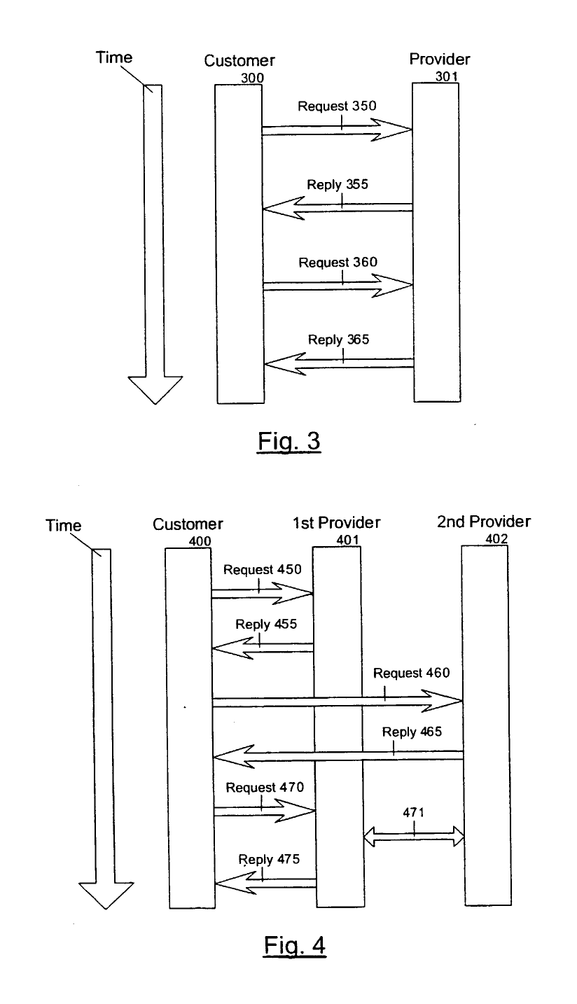

FIG. 3 shows the sequence of events when a customer transacts the purchase of goods or services from a provider over the Internet using an embodiment of this invention.

The customer's system or user-agent 300 sends a request 350 for information to a provider's system 301. The provider's system 301 sends a reply 355 describing the goods or services for sale back to the customer's system. For each possible transaction the reply 355 contains a link to another location at the provider's system 301 containing data identifying the possible transaction, e.g. a link associated with an offer to sell stock item number 47 might look like this:

http://www.P301.com/buy?object=47

When the customer decides to purchase one of the items described in reply 355, the customer takes an action that causes the customer's system 300 to use one of the links in reply 355 to send a request 360 to the provider's system 301. The request 360 contains information contained in link as well as a cookie previously stored at the customer's system 300 by the provider's system 301. In this example, the cookie contains an aggregation of the data that the customer must provide in order to allow a charge against the customer's credit card and possibly information that allows purchased goods to be delivered to the customer. The request 360 constitutes an order for goods or services and the provider's system 301 is now in possession of all the necessary information to proceed with the processing of this transaction.

The provider's system 301 attempts to charge the price of the goods or services ordered to the customer's credit card using whatever means it has at its disposal and communicates the success or failure of the transaction by sending a reply 365 to the customer's system 300.

### SECOND EXAMPLE

Three Parties—Customer, Vendor, Credit Agent

FIG. 4 shows the sequence of events using an embodiment of this invention when a customer places an order for goods or services with a first provider over the Internet and where the charge against the customer's credit card is handled by a second provider.

The customer's system or user-agent 400 sends a request 450 for information to a first provider's system 401. The first provider's system 401 sends a reply 455 describing the goods or services for sale. For each possible transaction the reply 455 contains a link to a location at a second provider's system 402. In this case the second provider is an agent for processing credit card transactions. Each of these links in reply 455 contains data identifying the possible transaction and identifying the first provider offering the transaction, e.g. a link associated with an offer to sell stock item number 9217 might look like this:

http://www.P402.com/buy?www.P401.com&object=9217

When the customer decides to purchase one of the goods or services described in reply 455, the customer takes an action that causes the customer's system 400 to use one of the links in reply 455 to send a request 460 to the second provider's system 402. The request 460 contains all the information contained in the selected link as well as a cookie previously stored at the customer's system 400 by the second provider's system 402. In this example the cookie contains an aggregation of the data that the customer must provide in order to allow a charge against the customer's credit card. The second provider's system 402 allocates an identifier for the transaction and constructs a new link to the first provider's system 401 which includes information from the selected link and this transaction identifier, e.g.

http://buy.P401.com/buy?object=9217&id402=a923f928-0bb39de1

The second provider's system 402 then sends a reply 465 to the customer's system 400 comprising a document containing the newly constructed link and remembers for a period of time an association of data comprising the customer's credit card details, the transaction identifier and any other information available that might be useful for the proposed transaction.

The reply 465 may either:

(a) cause the customer's system 400 to automatically send a request 470 to the first provider's system 401 (reply 465 is a redirect), or

(b) cause the customer's system 400 to arrange for the document contained in the reply 465 to be displayed to the customer. In order to proceed with the transaction the customer must then take a further action that causes the customer's system 400 to use the provided link to send a request 470 to the first provider's system 401.

In either case if the transaction proceeds then the first provider's system 401 receives from the customer's system 400 a request 470 which contains the transaction identifier allocated by the second provider's system 402 and other information from the selected link. Request 470 constitutes an order for the goods or services.

Before the first provider's system 401 can reply to the customer's system 400 and confirm or reject the transaction it must interact with the second provider's system 402 to attempt to effect a charge against the customer's credit card.

The first provider's system 401 establishes a communication link 471 with the second provider's system 402 using whatever means are available and provides the second provider's system 402 with the transaction identifier, the amount to be charged to the customer's credit card and any other information necessary to continue the transaction (e.g. a merchant account number and perhaps bank details for the payment of funds).

The second provider's system 402 attempts to correlate the transaction identifier with any transaction identifiers that it recently allocated and remembered. If this is successful then the second provider's system 402 now has all the necessary information and attempts to process the credit card transaction. The second provider's system 402 communicates the result of this attempt back to first provider's system 401 along with any other relevant information that the customer has authorised the second provider to disclose (possibly the customer's delivery address if physical delivery of goods is required).

The first provider's system 401 then sends a reply 475 to the customer's system 400 comprising a document reporting the status of the transaction and possibly containing another link to the second provider's system which includes the transaction identifier. The customer's system 400 may use this link to send a further request (not shown in FIG. 4) to the second provider's system 402 to get further information about the success or failure of the transaction which was not disclosed to or passed on by the first provider's system 401.

This example embodiment shows how the invention can be used to carry out e-commerce transactions while preserving as much as possible the privacy of the customer. Parties to the transaction receive only the information that they need to complete their part of the transaction. Information from the transactions need not be saved by the providers for later transactions as this invention furnishes the customer with the ability to efficiently provide the information whenever necessary in the form of a cookie.

Instead of charging a sum to the customer's credit card, the arrangement described in this example could be used to establish some other credential of the customer—perhaps that the customer is of sufficient age to legally purchase alcoholic beverages. Again there is no need for the vendor to know the identity of the customer, only that their credentials have been validated.

### THIRD EXAMPLE

Four Parties—Customer, Vendor, Credit Agency, Delivery Company

FIG. 5A shows the sequence of events using an embodiment of this invention when a customer orders goods over the Internet and several providers co-operate to transact the sale and delivery of those goods to the customer. The first provider is a vendor of various goods, the second provider is a credit card clearing agent, and the third provider is a company who will be responsible for the delivery of the item from the first provider to the customer.

As in the second example, a customer's system or user-agent 500 first sends a request 550 to a first provider's system 501. FIG. 5B-550 shows the request-line and headers from such a request made using the HTTP protocol to a provider with network name demoshop/dev.skea.com.

The first provider's system 501 sends a reply 555 with a page describing items for sale. For each possible transaction the reply 555 contains a link to a second provider's system 502. Each link contains references to a third provider's system 503 and data identifying the possible transaction and the provider offering the transaction, e.g. a link associated with stock item number 819 might look like this:

http://www.P502.com/buy?www.P503.com&www.P501.com&object=819

FIG. 5B-555 shows the status-line and headers from such a reply made using the HTTP protocol. The links to a second provider's system as discussed above would be conveyed in the body of the message and are not shown.

When the customer decides to purchase goods described in reply 555, the customer takes an action that causes the customer's system 500 to use one of the links in reply 555 to send a request 560 to the second provider's system 502. The request 560 contains all the information contained in the selected link as well as a cookie previously stored at the customer's system 500 by the second provider's system 502. In this example, the cookie contains an aggregation of the data that the customer must provide in order to allow a charge against the customer's credit card. FIG. 5B-560 shows the request-line and headers from such a request made using the HTTP protocol to a second provider with network name CredGuard-dev.skea.com. Line 1 (the request-line) contains the details of the selected link and the Cookie: header at line 7 contains several cookies previously stored at the customer's system by CredGuard-dev.skea.com.

The second provider's system 502 allocates an identifier for the transaction and constructs a link to the third provider's system 503 using information from first selected link and associates the transaction identifier with the first selected link, e.g.

http://www.P503.com/buy?www.P501.com&object=819&id502=AA287

The second provider's system 502 then sends a reply 565 to the customer's system 500 comprising a document containing the newly constructed link and remembers for a period of time an association of data comprising the customer's credit card details, the transaction identifier and any other information available that might be useful for the proposed transaction. FIG. 5B-565 shows the status-line and headers from such a reply made using the HTTP protocol and containing at line 4 the new link to the third provider's system with the information from the selected link and the newly allocated transaction identifier.

The reply 565 may either:

(a) cause the customer's system 500 to automatically send a request 570 to the third provider's system 503 (reply 565 is a redirect), or

(b) cause the customer's system 500 to arrange for the document contained in the reply 565 to be displayed to the customer. In order to proceed with the transaction the customer must then take a further action that causes the customer's system 500 to use the provided link to send a request 570 to the third provider's system 503.

In either case if the transaction proceeds then the third provider's system 503 receives from the customer's system 500 a request 570 which contains information from the link provided in reply 565 and possibly a cookie previously stored at the customer's system 500 by the third provider's system 503. In this example the cookie contains the address for delivery of goods to the customer. FIG. 5B-570 shows the request-line and headers from such a request made using the HTTP protocol to third provider with a network name PostMan-dev.skea.com. Line 1 (the request-line) contains the details of the provided link and the Cookie: header at line 7 contains two cookies previously stored at the customer's system by PostMan-dev.skea.com.

The third provider's system 503 allocates an identifier for the transaction and constructs a link to the first provider's system 501 using information contained in the request 570 and this transaction identifier, e.g.

http://www.P501.com/buy?object=819&id502=AA287&id503=1230af93

The third provider's system 503 then sends a reply 575 to the customer's system 500 comprising a document containing the newly constructed link and remembers for a period of time an association of data comprising the customer's delivery address, the transaction identifier just allocated and any other information available that might be useful for the proposed transaction. FIG. 5B-575 shows the status-line and headers from such a reply made using the HTTP protocol and containing at line 4 the new link to the first provider's system with the information from the earlier request and the newly allocated transaction identifier.

The reply 575 may either:

(a) cause the customer's system 500 to automatically send a request 580 to the first provider's system 501 (reply 575 is a redirect), or

(b) cause the customer's system 500 to arrange for the document contained in the reply 575 to be displayed to the customer. In order to proceed with the transaction the customer must then take a further action that causes the customer's system 500 to use the provided link to send a request 580 to the first provider's system 501.

In either case if the transaction proceeds then the first provider's system 501 receives from the customer's system 500 a request 580 which contains the transaction identifiers allocated by the second provider's system 502 and the third provider's system 503. The request 580 constitutes an order for the goods. FIG. 5B-580 shows the request-line and headers from such a request made using the HTTP protocol to a first provider with a network name DemoShop/dev.Skea.com. It is notable that there are no cookies being passed to the first provider in this request and the transaction identifiers allocated by the other providers are now present in line 1 (the request-line) of the request.

Before the first provider's system 501 can reply to the customer's system 500 and confirm or reject the purchase it must interact with the second provider's system 502 to attempt to effect a charge against the Customer's credit card and if successful with the third provider's system 503 to arrange delivery of the goods.

The first provider's system 501 establishes a communication link 581 with the second provider's system 502 using whatever means are available and provides the second provider's system 502 with the transaction identifier allocated by that system, the amount to be charged to the Customer's credit card and any other information necessary to continue the transaction (e.g. a merchant account number and perhaps bank details for the payment of funds).

The second provider's system 502 attempts to correlate the transaction identifier with any transaction identifiers that it recently allocated and remembered. If this is successful then the second provider's system 502 now has all the necessary information and attempts to process the credit card transaction. The second provider's system 502 communicates the result of this attempt back to the first provider's system 501 along with any other relevant information that the customer has authorised the second provider to disclose.

If the second provider's system 502 successfully processed the credit card transaction then the first provider's system 501 proceeds to establish a communication link 582 with the third provider's system 503 using whatever means are available and provides the third provider's system 503 with the identifier allocated by that system and any other information that the third provider's system 503 needs for effecting delivery of the purchased item.

On conclusion of its communications with the third provider's system 503, the first provider's system 501 then sends a reply 585 to the customer's system 500 comprising a document reporting the status of the transaction and possibly containing further links to the second provider's system 502 and the third provider's system 503 which include the relevant transaction identifiers allocated by those systems. FIG. 5B-585 shows the status-line and headers from such a reply made using the HTTP protocol. The links to the other providers' systems as discussed above would be conveyed in the body of the message and are not shown.

The customer's system 500 may use the further links in reply 585 (if present) to send further requests (not shown in FIG. 5A) to the second provider's system 502 and the third provider's system 503 containing the identifiers allocated by those systems to obtain further information about the payment or delivery aspects of the transaction that were not disclosed to or passed on by the first provider's system 501.

### FOURTH EXAMPLE

Four Parties—Customer, Vendor, Credit Agency, Delivery Company

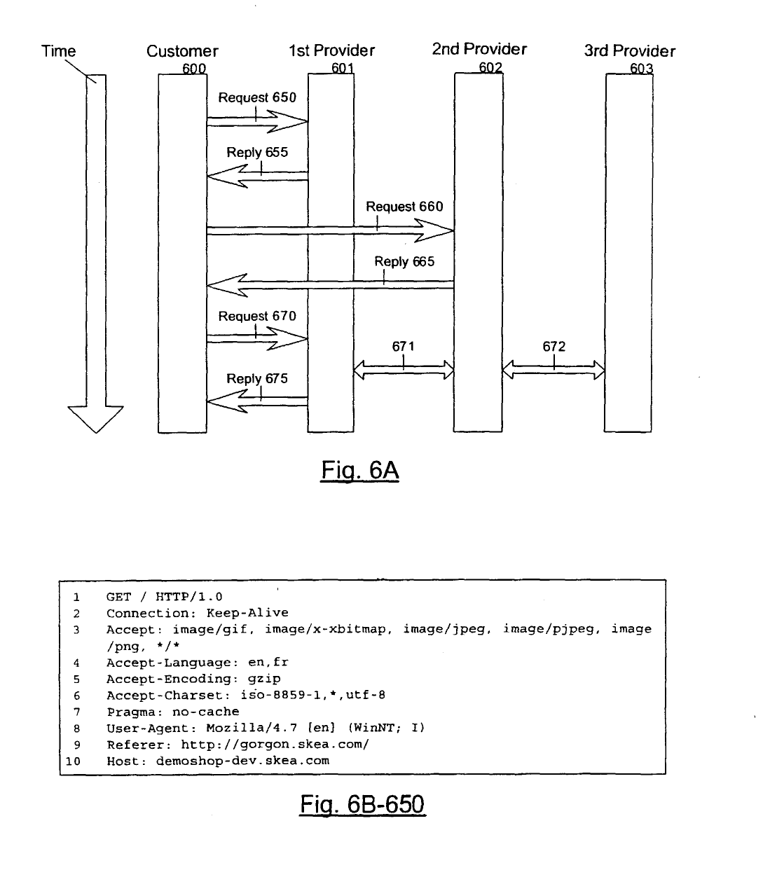

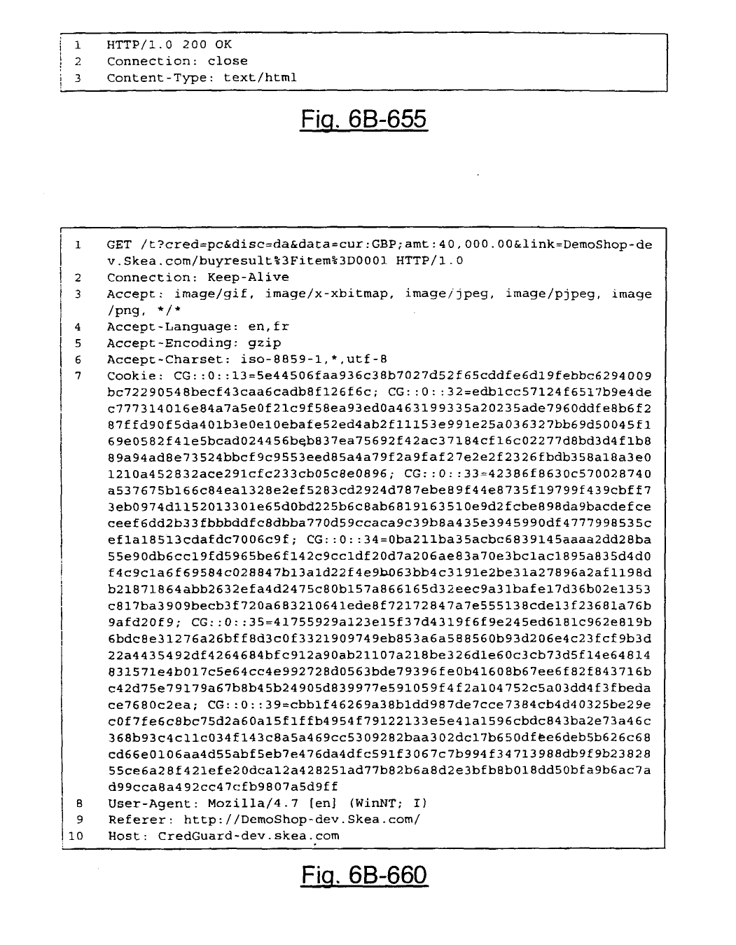

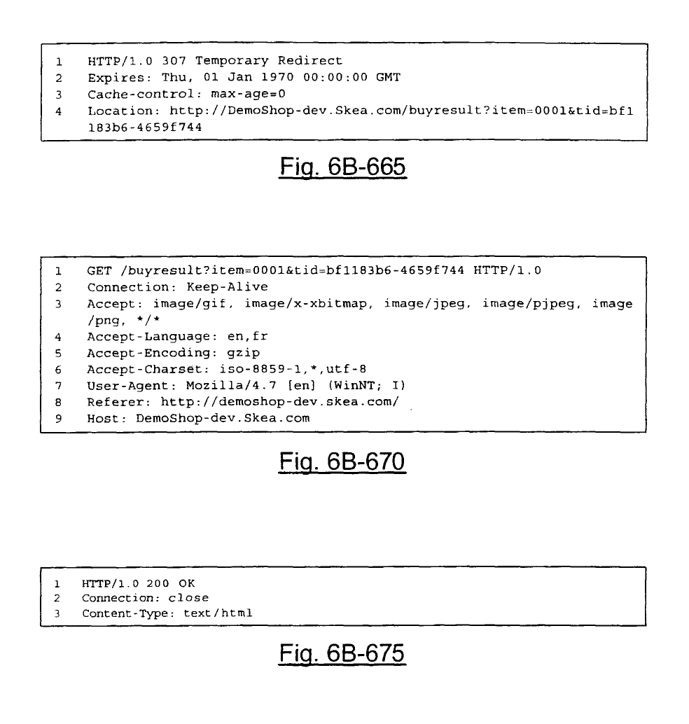

FIG. 6A shows the sequence of events using an embodiment of this invention when a customer orders goods over the Internet and several providers co-operate to transact the sale and delivery of those goods to the customer. The first provider is a vendor of various goods, the second provider acts as a credit card clearing agent and an information management agent, and the third provider is a company who will be responsible for the delivery of the item from the first provider to the customer.

As in the second example, a customer's system or user-agent 600 first sends a request 650 to a first provider's system 601. FIG. 6B-650 shows the request-line and headers form such a request made using the HTTP protocol to a provider with the network name demoshop/dev.skea.com.

The first provider's system 601 sends a reply 655 with a page describing items for sale. For each possible transaction the reply 655 contains a link to a second provider's system 602. In this example the second provider fulfils the roles of credit card clearing agent and information management agent as explained below. Each link contains:

(a) a reference to a third provider's system 603 and an indication of the information that is to be passed on to the third provider;

(b) data identifying the possible transaction; and

(c) data identifying the provider offering the transaction

e.g. a link associated with stock item number 819 might look like this:

http://www.P602.com/buy?deliver=www.P603.com&www.P601.com&object=819

FIG. 6B-655 shows the status-line and headers from such a reply made using the HTTP protocol. The links to a second provider's system as discussed above would be conveyed in the body of the message and are not shown.

When the customer decides to purchase an item described in reply 655, the customer takes an action that causes the customer's system 600 to use one of the links in reply 655 to send a request 660 to the second provider's system 602. The request 660 contains all the information contained in the selected link as well as any cookies previously stored at the customer's system 600 by the second provider's system 602. In this example there are two such cookies. The first cookie contains an aggregation of the data that the customer must provide in order to allow a charge against the customer's credit card. The second cookie contains an aggregation of the data that is necessary for the third provider to effect delivery of an item to the customer. FIG. 6B-660 shows the request-line and headers from such a request made using the HTTP protocol to a second provider with the network name CredGuard-dev.skea.com. Line 1 (the request-line) contains the details of the selected link and the Cookie: header at line 7 contains several cookies previously stored at the customer's system by CredGuard-dev.skea.com. In this example details required by the third provider have been stored at the customer's system by the second provider and are being returned to the second provider in the cookies accompanying this request. These details will be made available to the third provider by the second provider later in the course of the transaction if appropriate.

The second provider's system 602 allocates an identifier for the transaction and constructs a new link to the first provider's system 601 using information from the first selected link and this transaction identifier, e.g.

http://www.P601.com/buy?object=819&id602=09211-229

The second provider's system 602 then sends a reply 665 to the customer's system 600 comprising a document containing the newly constructed link and remembers for a period of time an association of data comprising the two cookies received in the request 660, the transaction identifier and any other information available that might be useful for the proposed transaction. FIG. 6B-665 shows the status-line and headers from such a reply made using the HTTP protocol and containing at line 4 the new link to the first provider's system with the information from the selected link and the newly allocated transaction identifier.

The reply 665 may either:

(a) cause the customer's system 600 to automatically send a request 670 to the first provider's system 601 (reply 665 is a redirect), or

(b) cause the customer's system 600 to arrange for the document contained in the reply 665 to be displayed to the customer. In order to proceed with the transaction the customer must then take a further action that causes the customer's system 600 to use the provided link to send a request 670 to the first provider's system 601.

In either case if the transaction proceeds the first provider's system 601 receives from the customer's system 600 a request 670 which contains all the information from the link provided in reply 665. The request 670 constitutes an order for the goods. FIG. 6B-670 shows the request-line and headers from such a request made using the HTTP protocol to a first provider with the network name DemoShop-dev.Skea.com. The newly allocated transaction identifier is contained in line 1 (the request-line) of the request.

Before the first provider's system 601 can reply to the customer's system 600 and confirm or reject the purchase it must interact with the second provider's system 602 to attempt to effect a charge against the customer's credit card and to arrange delivery of the goods.

The first provider's system 601 establishes a communication link 671 with the second provider's system 602 using whatever means are available and provides the second provider's system 602 with the transaction identifier allocated by that system, the amount to be charged to the customer's credit card, the information necessary for a delivery agent to collect the goods from the first provider and any other information necessary to continue the transaction (e.g. a merchant account number and perhaps bank details for the payment of funds).

The second provider's system 602 attempts to correlate the transaction identifier with any transaction identifiers that it recently allocated and remembered. If this is successful then the second provider's system 602 now has all the necessary information and attempts to process the credit card transaction. If the attempt is successful then the second provider's system 602 establishes a communications link 672 with the third provider's system 603 using whatever means are available and provides the third provider's system 603 with an association of data comprising the transaction identifier, the information necessary for a delivery agent to collect the goods from the first provider, the customer's delivery information which was contained in the second cookie of request 660 and any other details necessary for the third provider to effect collection and delivery from the first provider to the customer.

The second provider's system 602 communicates the result of the payment attempt back and the delivery arrangements to the first provider's system 601 along with any other relevant information that the customer has authorised the second provider to disclose.

On conclusion of its communications with the second provider's system 602, the first provider's system 601 then sends a reply 675 to the customer's system 600 containing the status of the transaction and possibly containing a further links to the second provider's system 602 and the third provider's system 603 both of which contain the transaction identifier allocated by the second provider's system 602. FIG. 6B-675 shows the status-line and headers from such a reply made using the HTTP protocol. The links to the other providers' systems as discussed above would be conveyed in the body of the message and are not shown.

The customer's system 600 may use the further links in reply 675 (if present) to send requests to the second provider's system 602 and the third provider's system 603 containing the transaction identifier to obtain further information about the payment or delivery aspects of the transaction that were not disclosed to or passed on by the first provider's system 601.

This example embodiment of the invention is preferred in circumstances where the customer is using a relatively slower means of accessing the network than the providers or where communications between the various parties are not wholly reliable. By managing the information that each provider might need and passing it along to the other providers as necessary the second provider's system 602 can take remedial action in the event that any one of the providers cannot be contacted or is unable to fulfil their part of the transaction. If the customer's system 600 were managing these interactions then it would likely have no alternative but to fail the entire transaction. By establishing second provider as an information manager, more transactions can be successfully completed. In addition, since the Providers are all likely to be connected to high-reliability, high speed networks, these interactions should take less time than if the customer's system 600 were in control of all the interactions.

One skilled in the art would appreciate that the process described in this example can be extended to any number of providers who perform any of a variety of services. For each additional provider the customer's system sends additional cookie data to the second provider's system as part of the request 660. The second provider then passes the appropriate information from to the appropriate provider and negotiates the performance of the service on behalf of the customer and other providers. In this way the second provider fulfils the role of an information management agent. The second provider's system has the facility for constructing cookies, extracting information from cookies and sending requests to the customer's system 600 to store new cookies or update old ones. The second provider's system can become the location for any customer to visit to enter and update the information stored in the cookies on the customer's system 600. This becomes more important if the cookies are encrypted to prevent network eavesdroppers from seeing the information they contain and where the customer does not necessarily hold the encryption key.

Flow Diagrams and Screenshots

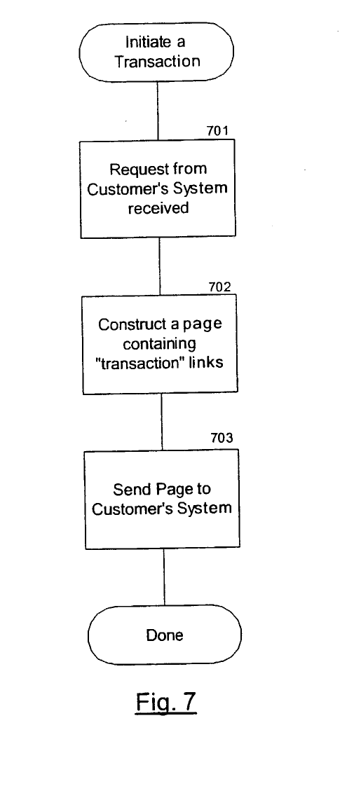

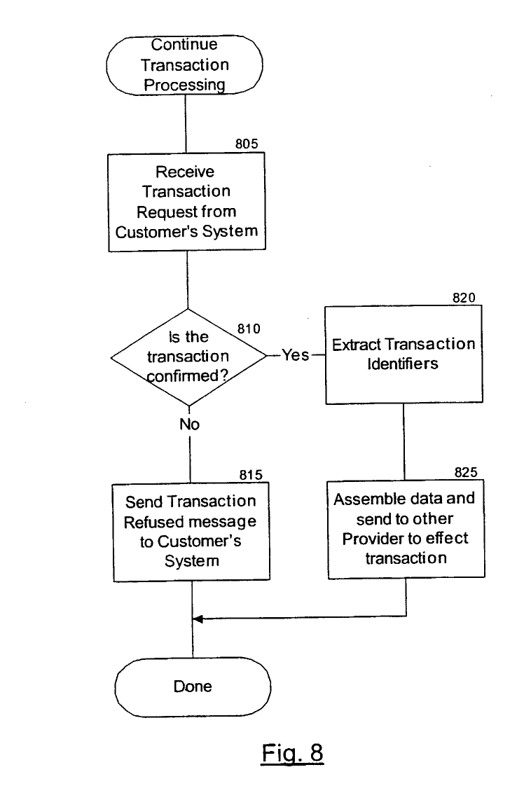

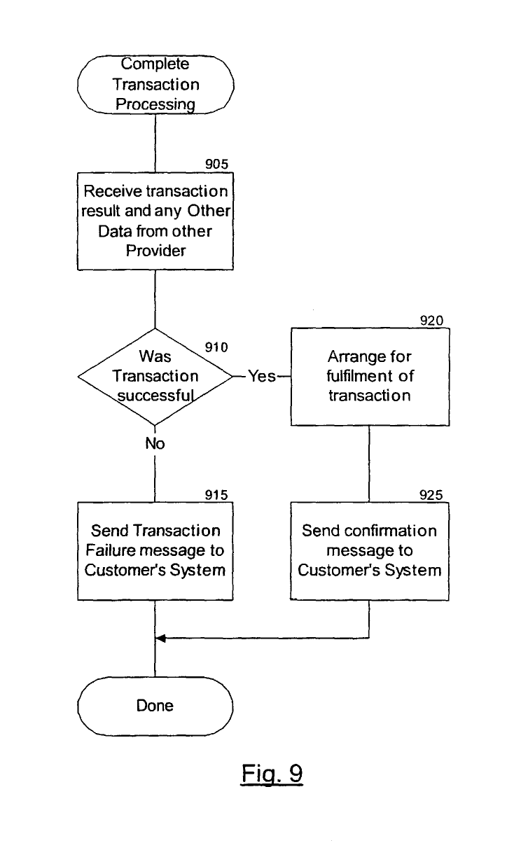

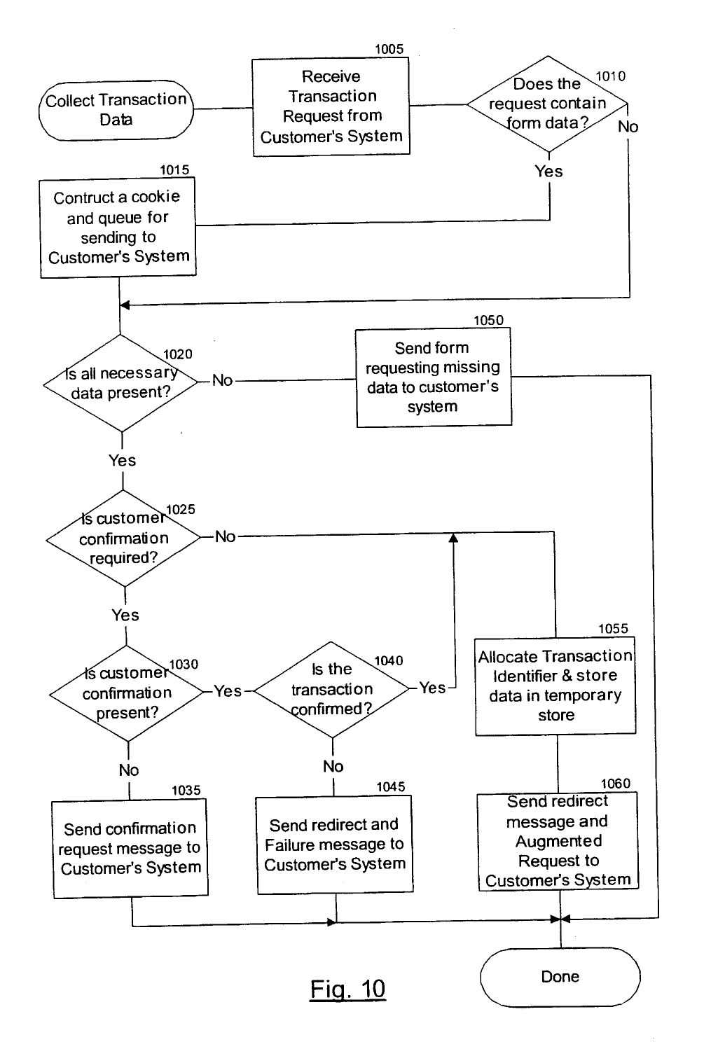

The flow diagrams in FIGS. 7-11 relate to an embodiment of this invention which involves a customer and two providers in an arrangement such as that shown in FIG. 4. A first provider proposes a transaction but requires the involvement of a second provider to effect some part of the transaction. FIGS. 7, 8 and 9 show steps performed by the first provider's system. FIGS. 10 and 11 show steps performed by the second provider's system. The discussion below will follow as much as possible the order of the events rather than the order of the diagrams so the flow diagrams will be discussed in the order FIG. 7, FIG. 10, FIG. 8, FIG. 11 and then FIG. 9. The systems illustrated by these flow diagrams differ from the systems illustrated in FIG. 4 in that a number of additional pairs of replies and requests from the second provider's system 402 to the customer's system 400 (a reply) and from the customer's system 400 to the second provider's system 402 (a request) may occur between request 450 and reply 465. These replies and requests are used when the customer has never before used the method of this invention for a particular piece of information which is needed for the transaction. They are used in order to provide the customer's system with the appropriate forms for entering the information and returning it to the second provider's system. The second provider's system then arranges for it's next reply to the customer's system to contain a cookie containing this information which will be stored at the customer's system for automatic disclosure to the second provider during future requests. The additional replies and requests are also used to obtain confirmation of the transaction from the customer if that is required. In the systems illustrated in FIGS. 7-11 this confirmation is always returned to the second provider's rather than allowing the transaction to immediately continue at the first provider's system as suggested by the discussion relating to FIG. 4. The subsequent and final reply from the second provider's system to the customer's system always instructs the customer's system to automatically continue with it's request at the first provider's system (it is a redirect message). These differences notwithstanding, references will be made to FIG. 4 where corresponding processes are described.

FIGS. 12-16 show screenshots of pages created by a second provider's system for display by a customer's system in an embodiment of this invention at a second provider similar to that illustrated by the flow diagram in FIG. 10. These will be referred to as appropriate in the description of FIG. 10.

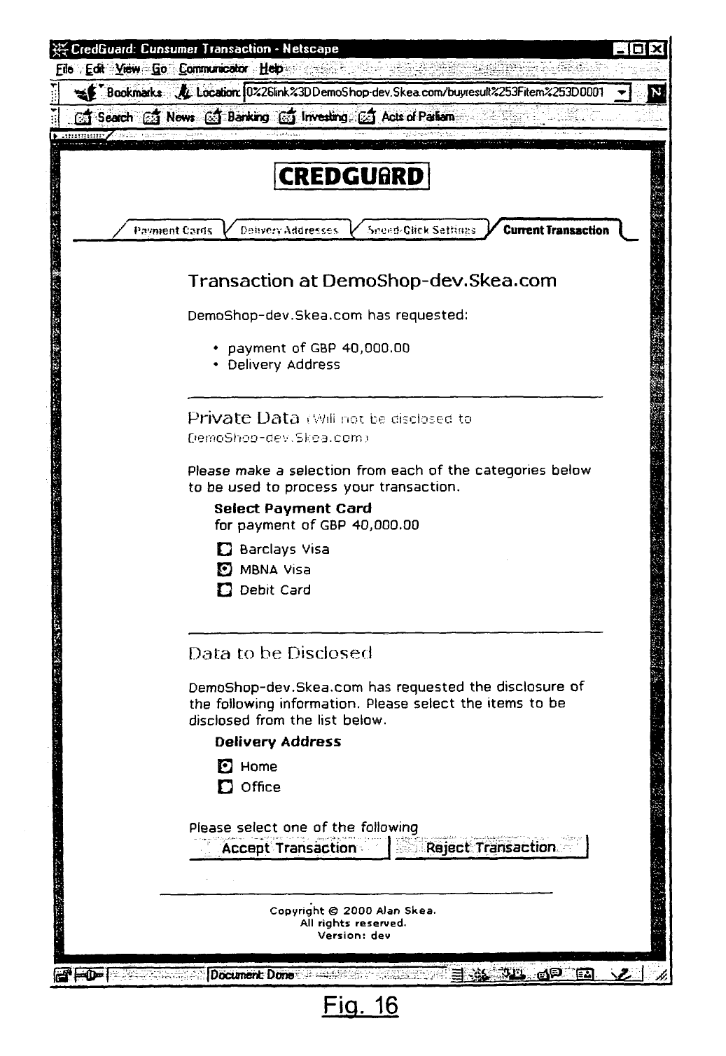

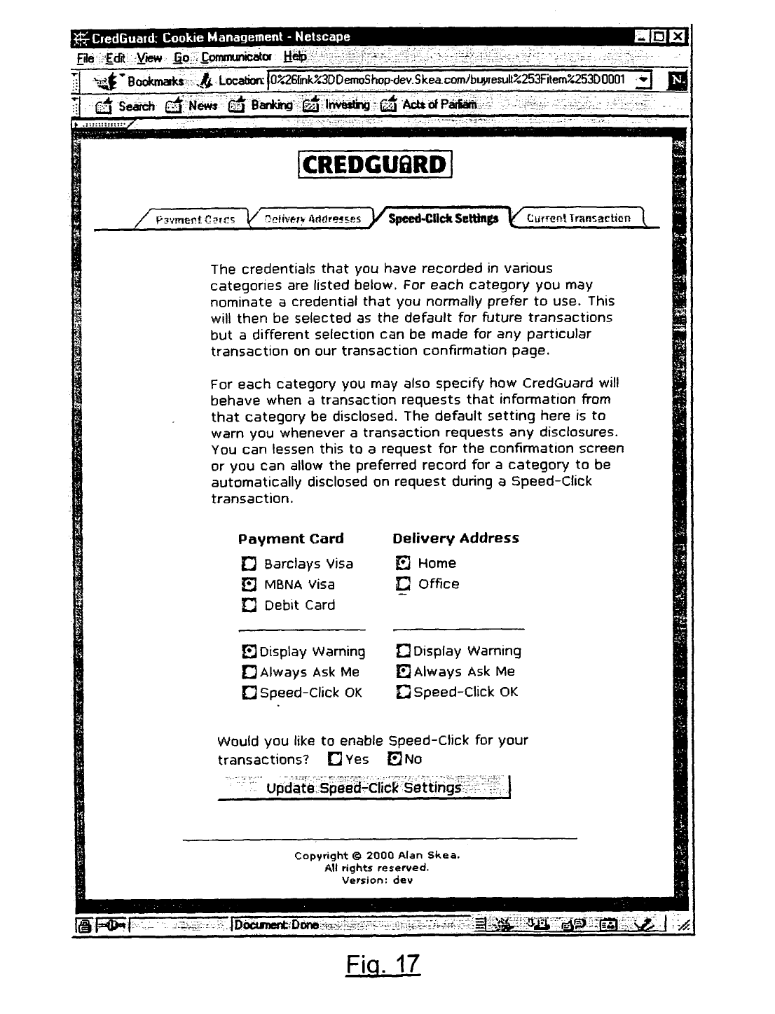

FIG. 17 is an additional screenshot of a page created by an embodiment of this invention at a second provider's system that allows the customer to specify transaction preferences which will further streamline future transactions.

A First Provider's System Proposes One or More Transactions

FIG. 7 is a flow diagram of the steps taken by an embodiment of this invention at a first provider's system to propose one or more transactions to a customer. The customer's system initiates the interaction by sending a request for a web page to the first provider's system. In step 701 the first provider's system receives this request (this corresponds to request 450 in FIG. 4). In step 702 the first provider's system constructs a web page containing offers of transactions, each offer accompanied by a link to a second provider's system constructed so that it contains data identifying the transaction to the first provider, data identifying a page at the first provider's system at which the transaction might be continued and other information related to the transaction which might be required by the second provider to effect its part of the transaction. In the second example above which is illustrated by FIG. 4 these links might have the form:

http://www.P402.com/buy?cred=pc&disc=da&link=www.P401.com/buy?object=9217

In this example the page at the first provider's system at which the transaction is to be continued after the second provider has effected its part of the transaction is http://www.P401.com/buy. The data identifying the transaction to the first provider is ?object=9217 and the other information required by the second provider to effect its part of the transaction is ?cred=pc&disc=da.

In step 703, the first provider's system sends the page just constructed to the customer's system (this corresponds to reply 455 in FIG. 4).

The Customer's System Sends a Transaction Request to a Second Provider's System.

FIG. 10 is a flow diagram of the steps taken by an embodiment of this invention at a second provider's system to collect transaction data from a customer's system. When a customer selects a link such as that generated by the first provider's system described above, a transaction request is sent to the second provider's system. In step 1005 the second provider's system receives this request (this corresponds to request 460 in FIG. 4). Some information in the request may have been provided by the customer by filling in a form sent in an earlier stage of the transaction process (i.e. by step 1050 in an earlier cycle through this flow diagram). Step 1010 tests for the presence of data entered at the customer's system via a form and if there is none control moves on to step 1020. If form data was found at step 1010 then step 1015 encodes the data into a cookie and queues the cookie for sending as part of the next message to the customer's system. The customer's system can store this cookie and provide it to the second provider's system automatically in future requests (FIG. 13 shows a customer's system displaying a cookie so received and requesting customer approval for storing the cookie; FIG. 14 shows a customer's system displaying a confirmation message to which the cookie was attached).

In order for the second provider to effect its part of the transaction it must have all the necessary information. Some of this information may have been provided automatically by the customer's system in the form of cookies accompanying the request. Step 1020 checks that all the necessary information is available at the second provider's system. If some information has not been provided then step 1050 sends a reply to the customer's system which prompts the customer to enter some or all of the missing data (FIGS. 12 and 15 show examples of forms displayed by the customer's system for entry and management of such data). The routine represented by the flow diagram in FIG. 10 is then complete though the customer may choose to continue with the transaction by entering the missing data into the form provided in the message and using a link also provided in the message to send a new transaction request to the second provider's system in which case the routine begins afresh with step 1005.

If the tests at step 1020 determine that all the necessary data is present then control moves to step 1025 to see if the customer has asked for a confirmation step before committing to the transaction. This request for a confirmation step may be encoded as a preference in a cookie or it may accompany the transaction request in another form. If a confirmation step is required then control moves to step 1030, otherwise it is assumed that the customer approves the transaction and control moves to step 1055.

Step 1030 determines if a customer confirmation or rejection has accompanied the current transaction request. If not then control moves to step 1035 which sends a message to the customer's system detailing the proposed transaction and requesting a confirmation or rejection from the customer (FIG. 16 shows an example of a customer's system displaying such a request for confirmation). The routine represented by the flow diagram in FIG. 10 is then complete though the customer may choose to continue with the transaction by using either the confirmation or rejection link provided in the message to send a new transaction request to the second provider's system in which case the routine begins afresh with step 1005.

If step 1030 finds a customer confirmation or rejection accompanying the transaction request then control moves to step 1040 where confirmation and rejection are distinguished. If a rejection accompanied the transaction request then step 1045 constructs a transaction failure message containing a re-direction to the continuation page at the first provider's system and this message is sent to the customer's system (this corresponds to Reply 465 in FIG. 4). The routine represented by the flow diagram in FIG. 10 is then complete. If the customer's system performs the redirect to the first provider's system then the transaction continues there as shown in FIG. 8.

If step 1040 determines that a confirmation message accompanied the transaction request then control moves to step 1055. Step 1055 allocates an identifier for the proposed transaction and stores for a short period an association of data comprising this identifier and any other information necessary to effect the transaction. This association of data will contain only the information that is currently available to the second provider's system which may not be all the information necessary to effect the transaction. Any other information required to effect the transaction is expected to be supplied by the first provider within the period for which the second provider's system stores the association of data (perhaps a few seconds). This interaction is illustrated in FIGS. 8 and 11.

Finally, step 1060 sends a reply to the customer's system comprising the transaction identifier allocated in step 1055 and a re-direction to the continuation page at the first provider's system (this corresponds to Reply 465 in FIG. 4). The routine represented by the flow diagram in FIG. 10 is then complete. If the customer's system performs the redirect to the first provider's system then processing continues there as shown in FIG. 8.

The First Provider's System Continues the Transaction

FIG. 8 is a flow diagram of the steps taken by an embodiment of this invention at a first provider's system to continue a transaction after customer data has been provided to a second provider's system by a customer's system. In step 805 a request to continue or discontinue a transaction is received from the customer's system (this corresponds to Request 470 in FIG. 4). Step 810 distinguishes the customer's acceptance from their rejection of the transaction. If the transaction was accepted then control moves to step 820. Otherwise (the customer rejected the transaction) step 815 sends a message to the customer's system confirming that the transaction was rejected (this corresponds to Reply 475 in FIG. 4) and the routine represented by the flow diagram in FIG. 8 is complete.

If the transaction was accepted (either explicitly by the customer or automatically) then the transaction request received in step 805 contains a transaction identifier allocated by the second provider's system. Step 820 extracts this transaction identifier from the transaction request and step 825 creates an association of data containing this transaction identifier along with any other information that the second provider requires from the first provider in order to effect its part of the transaction. This association of data is then sent to the second provider using whatever means are available. Different embodiments of the invention might use different means to send this message. An embodiment that uses the internet for communication between the customer and the first provider and between the customer and the second provider might use a private line leased from a phone company for communication between the first provider and the second provider. The routine represented by the flow diagram in FIG. 8 is then complete and transaction processing continues at the second provider's system as shown in FIG. 11.

The Second Provider's System Processes the Transaction

FIG. 11 is a flow diagram of the steps taken by an embodiment of this invention at a second provider's system to correlate transaction data from a first provider's system with temporarily stored data from a customer's system and then process the transaction. In step 1105 a message is received from the first provider's system containing details of the proposed transaction including a transaction identifier earlier allocated by the second provider's system using a routine such as that illustrated by the flow diagram in FIG. 10. Step 1110 examines the temporary store to see if it contains an aggregation of data containing this transaction identifier. If no such data is found in the store then control moves to step 1140 which sends an Invalid Transaction message back to the first provider's system. The routine represented by the flow diagram in FIG. 11 is then complete and transaction processing continues at the first provider's system as shown in FIG. 9.

If data with a corresponding transaction identifier is found at step 1110 then control moves to step 1115 where the data is retrieved from the temporary store and aggregated with the data received from the first provider's system in the transaction request. This aggregation of data is now everything that is needed for the second provider's system to effect its part of the overall transaction and step 1120 attempts to do so. There is no assurance that data supplied by the customer's system or by the first provider's system will be correct or will result in the second provider's system being successful in this attempt. For example, if the second provider is attempting to make a charge to a customer's credit card, this may fail because the bank that issued the credit card may not authorise the transaction. However, until the second provider's system makes the attempt to charge the credit card with all the data that might be necessary this result will not be know.

Step 1125 checks the result of the transaction performed in step 1120. If the transaction failed then control moves to step 1130 and a message indicating a transaction failure is sent to the first provider's system. If the transaction succeeded then control moves instead to step 1135 and a message indicating the success of the transaction is sent to the first provider's system. This message might be accompanied by other data such as a transaction code or other data which the customer has authorised the second provider's system to disclose to the first provider. For example, a delivery address might be needed to enable a first provider to fulfil a purchase and the second provider might mediate the disclosure of this delivery address for transactions that succeed. In both cases (success or failure of the transaction) the routine represented by the flow diagram in FIG. 11 is then complete and transaction processing continues at the first provider's system as shown in FIG. 9.

The First Provider's System Concludes the Transaction

FIG. 9 is a flow diagram of the steps taken by an embodiment of this invention at a first provider's system to conclude a transaction after a second provider's system has attempted to effect part of the transaction. Step 905 receives a message from the second provider's system which contains an indication as to whether the second provider's part of the transaction was successful. Step 910 examines this indication and if it indicates failure then control moves to step 915 which sends a failure message to the customer's system (this corresponds to Reply 475 in FIG. 4).

If in step 910 the indication shows that the second provider's part of the transaction succeeded then control moves to step 920 and the first provider's system performs any additional parts of the transaction that have yet to be performed, such as arranging for the fulfilment of a purchase. Step 925 then sends a message containing confirmation and details of the successful transaction to the customer's system (this corresponds to Reply 475 in FIG. 4). This message (and also the failure message of step 915) may refer the customer to the second provider for further details of the transaction which were not revealed to the first provider. The routine represented by the flow diagram in FIG. 9 is then complete and with the exception of any actions taken by the customer's system, so is the overall transaction.

Further Embodiments

It is anticipated that users of this invention will want to store many of their regularly used credentials using this method and will want access to their stored credentials in a variety of circumstances. While the initial embodiments will work with software that most internet users already have installed, it is anticipated that there will be a demand for additional functionality that can only be provided by an additional piece of software. This additional piece of software would allow the users to better manage the cookies that have been set on their system and may mediate all their interactions with the networks in order to better provide these management services. The additional software could also provide better integration with other software that the user regularly users, such as an email user-agent.

Another possible extension might be to add a smart-card reader to the customer's system and arrange for the smart-card to mediate access to the network. The cookies encoding the user's credentials could then all be stored in the smart-card and could then be carried from place to place and used through a variety of different network access terminals.

Cell-phones present another opportunity to store cookies for use on the move. Cell-phones that are equipped with WAP are ideal devices for the portable storage of credentials in cookies. With the recent addition of wireless networking to some of these devices they have the potential to be used to mediate transactions involving other equipment—vending machines, for example.

Conclusions, Ramifications and Scope of the Invention

A method and system have been described whereby a customer can enter into a transaction with one or more providers with a means of efficiently disclosing to each provider only the information necessary for that provider to effect their part of the transaction. The method allows the customer to retain custody of all their personal information and disclose it only as and when they choose. Additional advantages of the invention are that:

it allows a customer to store information required by particular providers once and use the stored information many times without re-entering;

it provides customers with a central location for the maintenance of their stored information;

it allows providers to discard customer information as soon as their need for it expires and thus avoid customer concerns over data security and simplify compliance with various data protection legislation;

it provides a streamlined method for carrying out online transactions which lowers the barriers to online purchasing and facilitates impulse buying.

Although the description of the invention above is in terms of various embodiments this should not be construed as limiting the scope of the invention but as merely providing illustrations of some of the presently preferred embodiments of the invention. For example, a provider's system might instead be a collection of systems that together provide functionality equivalent to the system in the descriptions above; the cookies might be encrypted before being returned to protect them from network eavesdroppers; a customer's system might be enhanced to provide cookie-management functions some of which are the here described as part of a provider's system, etc.

Accordingly, the scope of the invention should be determined by the appended claims and their legal equivalents, rather than by the descriptions of the example embodiments.

What is claimed is:

1. An improved user agent that may be employed by a user to interact via a network with a service in order to perform a transaction with a provider, the improvement comprising:
an interface in the user agent for receiving user information from the user, indicating to the user that the user information will not be retained in the service after a transaction, receiving transaction-invariant user information made by the server using the received user information, and storing the transaction-invariant user information in the user agent; and
an operation in the user agent that outputs the user agent-stored transaction-invariant user information to the service, the operation requiring substantially less user interaction by the user with the user agent than that required to input the user information contained in the user agent-stored transaction-invariant user information to the user agent.

2. The improved user agent set forth in claim 1 wherein;
the user agent-stored transaction-invariant user information includes personal identification information which identifies the user.

3. The improved user agent set forth in claim 2 wherein:
the personal identification information identifies the user to the provider.

4. The improved user agent set forth in claim 2 wherein:
the personal identification information identifies the user to an additional participant in the transaction.

5. The improved user agent set forth in claim 4 wherein:
the additional participant sends a message to the service which vouches for the user with regard to the transaction.

6. The improved user agent set forth in claim 5 wherein:
the message vouches for the credit-worthiness of the user.

7. The improved user agent set forth in claim 1 wherein:
the user agent-stored transaction-invariant user information includes contact information which specifies how the user may be contacted during the transaction.

8. The improved user agent set forth in claim 1 wherein:
the user agent-stored transaction-invariant user information includes shipping information which specifies how an item which is involved in the transaction may be shipped.

9. The improved user agent set forth in claim 1 wherein:
the user agent-stored transaction-invariant user information includes payment information which specifies how a payment that is related to the transaction will be made.

11. The improved user agent set forth in any one of claims 1 through 9 wherein:
the user agent-stored transaction-invariant user information received from the service is encrypted.

12. The improved user agent set forth in any of claims 1 through 9 wherein:
the transaction is associated with a network address to which the service responds; and
the operation is selecting the network address.

13. The improved user agent set forth in claim 12 wherein:
the network address is associated with the user agent-stored transaction-invariant user information in the user agent.

14. The improved user agent set forth in claim 13 wherein:
the user agent-stored transaction-invariant user information is locatable using the associated network address.

15. The improved user agent set forth in claim 14 wherein:
the received user agent-stored transaction-invariant user information is included in a cookie which the service provides to the user agent.

16. The improved user agent set forth in claim 15 wherein:
the service encrypts at least the user agent-stored transaction-invariant user information in the cookie.

17. An improved service which interacts via a network and a user agent with a user to perform a transaction between a provider and the user, the transaction requiring transaction-invariant user information and the improvement comprising:
a first interface with the user agent for receiving user information from the user, indicating to the user that that user information will not be retained in the service after a transaction, making transaction-invariant user information from the user information, and returning the transaction-invariant user information to the user agent for storage therein; and
a second interface for receiving user agent-stored transaction-invariant user information from the user agent during the transaction, the user agent-stored transaction-invariant user information permitting the service to perform the transaction without either using transaction-invariant user information retained from a previous transaction between the provider and the user or requiring the user to input additional transaction-invariant user information during the transaction.

18. The improved service set forth in claim 17 wherein:
the user agent-stored transaction-invariant user information includes personal identification information which identifies the user.

19. The improved service set forth in claim 18 wherein:
the personal identification information identifies the user to the provider.

20. The improved service set forth in claim 18 wherein:
the personal identification information identifies the user to an additional participant in the transaction.

21. The improved service set forth in claim 20 wherein:
the additional participant sends a message to the service which vouches for the user with regard to the transaction.

22. The improved service set forth in claim 21 wherein:
the message vouches for the credit-worthiness of the user.

23. The improved service set forth in claim 17 wherein:
the user agent-stored transaction-invariant user information includes contact information which specifies how the user may be contacted during the transaction.

24. The improved service set forth in claim 17 wherein:
the user agent-stored transaction-invariant user information includes shipping information which specifies how an item which is involved in the transaction may be shipped.

25. The improved service set forth in claim 17 wherein:
the user agent-stored transaction-invariant user information includes payment information which specifies how a payment that is related to the transaction will be made.
Please cancel claim 26.

27. The improved service set forth in claim 17 wherein:
the user agent-stored transaction-invariant user information maker encrypts the user agent-stored transaction-invariant user information before returning the user agent-stored transaction-invariant user information to the user agent.

28. The improved service set forth in claim 27 wherein:
the transaction is associated with a network address to which the service responds; and
the user agent-stored transaction-invariant user information maker associates the user agent-stored transaction invariant user information with the network address.

29. The improved service set forth in claim 27 wherein:
the user agent-stored transaction-invariant user information maker includes the user agent-stored transaction-invariant user information in a cookie which the service returns to the user agent.

30. The improved service set forth in claim 29 wherein:
the user agent-stored transaction-invariant user information maker encrypts the user agent-stored transaction-invariant user information included in the cookie.

31. The improved service set forth in any of claims 17 through 25 further comprising:
a transaction identifier that is associated with the transaction.

32. The improved service set forth in claim 31 wherein:
the transaction identifier is associated with the received user agent-stored transaction-invariant user information.

33. The improved service set forth in claim 31 wherein:
another service is involved in the transaction;
one of the services provides the transaction identifier to the user agent and the user agent provides the transaction identifier to the other service; and
if either service provides the other with further information for the transaction, the further information is provided together with the transaction identifier,
whereby each service is able to associate the further information with the transaction.

34. The improved service set forth in claim 33 wherein:
the user agent provides the transaction identifier together with user agent-stored transaction-invariant transaction user information to the other service.

35. The improved service set forth in claim 34 wherein:
the user agent-stored transaction-invariant user information is particular to the other service.

36. A method of providing information for a transaction between a user and a provider that is performed by user agent for the user and a service for the provider, the user agent and service employing the HTTP protocol or an equivalent therefor and the transaction requiring transaction-invariant user information that is not retained in the service after the transaction and
the method comprising the steps performed before the transaction of:
collecting the transaction-invariant user information from the user in the user agent using an interface that indicates to the user that the transaction-invariant user information will not be retained in the service after a transaction,
sending a message from the user agent to the service according to the protocol that includes the transaction-invariant user information,
using the transaction-invariant user information in the service to make a cookie that is associated with a universal resource identifier, and
returning the cookie to the user agent according to the protocol for storage therein; and the steps performed during the transaction of:
receiving a message according to the protocol in the user agent, the message including the universal resource identifier; and
responding to selection of the universal resource identifier in the user agent by sending a message according to the protocol, the message including the cookie associated with the universal identifier and being directed as specified by the universal resource identifier.
Please cancel claims 37 and 38.

39. A method of performing a transaction between a user and a provider in a service that employs the HTTP protocol or an equivalent therefor,
the method comprising the steps of:
receiving a first message according to the protocol from a user agent belonging to the user, the message having a header that contains a cookie made from transaction-invariant user information, the transaction-invariant user information permitting the service to perform the transaction without either using transaction-invariant user information retained by the service from a previous transaction between the provider and the user or requiring the user to input additional transaction-invariant user information during the transaction and the user having provided the transaction-invariant user information used to make the cookie in response to a message stating that the service would not retain the transaction-invariant user information between transactions;
using the transaction-invariant user information from the cookie in the transaction, and
thereafter rendering the transaction-invariant user information unusable to the service for a future transaction.

40. The method set forth in claim 39 further comprising the step performed prior to the beginning of the transaction of:
sending a second message according to the protocol to the user agent, the second message's header containing a set cookie response header and a cookie made from the transaction-invariant user information.

41. The method set forth in claim 40 further comprising the step performed prior to the beginning of the transaction of:
receiving a third message according to the protocol from the user agent that contains the transaction-invariant user information.

42. The method set forth in claim 40 wherein another service is involved in the transaction and the method further comprises the steps of:
associating the transaction with a transaction identifier in one of the services;
in the one service, sending a fourth message according to the protocol to the user agent, the fourth message having a header that includes a universal resource identifier that is responded to by the other service and associated therewith, the transaction identifier; and
receiving further information for the transaction together with the transaction identifier from the other service,
whereby the one service is able to associate the further information with the transaction.

43. The method ser forth in claim 42 wherein the universal resource identifier is associated with a cookie containing further transaction-invariant user information in the user agent and the method further comprises the steps performed in the other service of
receiving a fifth message according to the protocol from the user agent, the fifth message including the universal resource identifier and the transaction identifier and the fifth message's header including the cookie.

44. The method set forth in claim 43 wherein the methos further comprises the step performed in the other service of:
sending a sixth message according to the protocol to the user agent, the sixth message's header containing a set cookie response header and a cookie made from the further transaction-invariant user information.

45. A method employed in a user agent associated with a userin a transaction to pass a transaction identifier for the transaction from a first service that is participating in the transaction to a second service that is participating in the transaction, the services and the user agent employing the HTTP protocol or an equivalent therefor to communicate with one another and the method comprosing the steps performed in the user agent of:
receiving a redirect status message according to the protocol from the first service, the redirect status message including a universal resource identifier that specifics the second service and has the transaction identifier associated therewith; and
responding to the redirect status message by sending a request message according to the protocol that has the universal resource identifier and the transaction identifier associated therewith as the request-URI.
